(19) United States
(12) Patent Application Publication
(10) Pub. No.: US 2017/0019944 A1
(43) Pub. Date: Jan. 19, 2017

(54) Dual Connectivity for User Equipment Having One Carrier Sending Capability

(71) Applicant: Marvell World Trade Ltd., St. Michael (BB)

(72) Inventors: Yue Teng, Shanghai (CN); Xuan Zhou, Fremont, CA (US); Shiyi Zhu, Shanghai (CN)

(21) Appl. No.: 15/199,530

(22) Filed: Jun. 30, 2016

Related U.S. Application Data
(60) Provisional application No. 62/192,128, filed on Jul. 14, 2015.

(51) Int. Cl. H04W 76/02; H04L 1/18; H04L 5/00; H04W 72/12; H04W 16/32

(52) U.S. Cl. CPC H04W 76/025; H04W 72/1268; H04W 16/32; H04L 5/0005; H04L 1/1812; H04L 1/1861; H04W 84/042

(57) ABSTRACT

The present disclosure describes systems and techniques relating to wireless communications by devices that include a communication device including: a radio unit configured to communicate wirelessly in accordance with a wireless communication system; and a controller coupled with the radio unit, the controller configured to (i) obtain a time division uplink resource that indicates both a first set of time slots and a second set of time slots, which are different than the first set, to support dual connectivity with a macro cell station and a micro cell station of the wireless communication system in which the macro cell station and the micro cell station are coupled with each other through a non-ideal backhaul, (ii) send first feedback data to the macro cell station using the first set of time slots, and (iii) send second feedback data to the micro cell station using the second set of time slots.

### CROSS REFERENCE TO RELATED APPLICATIONS

This application claims the benefit of the priority of U.S. Provisional Application Ser. No. 62/192,128, filed Jul. 14, 2015 and entitled “IMPLEMENTATION OF LTE DUAL CONNECTIVITY FOR USER EQUIPMENT MERELY HAVING ONE CARRIER SENDING CAPABILITY”, which is incorporated herein by reference in its entirety.

### TECHNICAL FIELD

The present disclosure describes systems and techniques relating to wireless communications, in particular, to a method and an apparatus for implementing dual connectivity for a user equipment merely having one carrier sending capability.

### BACKGROUND

To support Long Term Evolution (LTE) Dual Connectivity (DC) for a user equipment (UE), typically a UE type 2 is designed, where the UE supports sending two uplink carriers simultaneously, and the UE has two radio frequency (RF) sending paths. A first RF sending path is used as the uplink carrier for the macro cell, and a second RF sending path is used as a second, distinct uplink carrier for the micro cell. This is in contrast to a UE type 1, which has one uplink carrier for both the macro cell and the micro cell. Moreover, DC is distinct from Carrier Aggregation (CA) in LTE, since CA uses an ideal backhaul that connects the macro cell with the micro cell, allowing downlink feedback for the micro cell to be sent to the macro cell, which in turn can communicate this information to the micro cell over the ideal backhaul.

### SUMMARY

The present disclosure describes systems and techniques relating to wireless communications. According to an aspect of the described systems and techniques, a communication device includes: a radio unit configured to communicate wirelessly in accordance with a wireless communication system; and a controller coupled with the radio unit, the controller configured to (i) obtain a time division uplink resource that indicates both a first set of time slots and a second set of time slots, which are different than the first set, to support dual connectivity with a macro cell station and a micro cell station of the wireless communication system in which the macro cell station and the micro cell station are coupled with each other through a non-ideal backhaul, (ii) send first feedback data to the macro cell station using the first set of time slots, and (iii) send second feedback data to the micro cell station using the second set of time slots.

The wireless communication system can be an LTE (Long-Term Evolution) wireless communication system, and the controller can be configured to: send the first feedback data to the macro cell station on a first uplink channel in a first frequency band (e.g., a 1850-1910 MHz frequency band); d send the second feedback data to the micro cell station on a second uplink channel in a second frequency band (e.g., a 1710-1755 MHz frequency band). The radio unit can be configured to communicate wirelessly over a radio frequency (RF) sending path in accordance with the wireless communication system specifying sub-frames used to communicate wirelessly over the RF sending path, the time division uplink resource indicates both a first proper subset of the sub-frames as the first set of time slots and a second proper subset of the sub-frames as the second set of time slots, and the controller is configured to: send the first feedback data to the macro cell station on an uplink carrier using the first proper subset of the sub-frames over the RF sending path; and send the second feedback data to the micro cell station on the same uplink carrier using the second proper subset of the sub-frames over the same RF sending path.

The time division uplink resource can indicate the first and second proper subsets of sub-frames within a Frequency Division Duplex (FDD) wireless communication protocol. The first proper subset of the sub-frames can be sub-frames 0, 2, 4, 6 and 8, and the second proper subset of the sub-frames can be sub-frames 1, 3, 5, 7 and 9. Further, in some implementations, the controller is configured to calculate and store acknowledgement/negative acknowledgement (ACK/NACK) results for both the macro cell station and the micro cell station using a downlink decoder, the time division uplink resource can indicate a sub-frame n for uplink use of the macro cell station and a sub-frame m for uplink use of the micro cell station, and the controller can be configured to (i) determine hybrid automatic repeat request acknowledgement (HARQ-ACK) feedback for the macro cell station based on a downlink sub-frame n-4 and a downlink sub-frame n-5, and (ii) determine HARQ-ACK feedback for the micro cell station based on a downlink sub-frame m-4 and a downlink sub-frame m-5.

According to another aspect of the described systems and techniques, a method includes: receiving from a first base station, at a wireless device, information specifying a division of an uplink resource for the wireless device, wherein the first base station supports radio frequency (RF) wireless communications in a first area; receiving from the first base station, at the wireless device, wireless communications in first downlink sub-frames; receiving from a second base station, at the wireless device, wireless communications in second downlink sub-frames, wherein the second base station supports RF wireless communications in a second area that overlaps with the first area, and the second base station is coupled with the first base station through a non-ideal backhaul; processing the wireless communications in two or more of the first downlink sub-frames to prepare first base station downlink feedback information for the two or more first downlink sub-frames; processing the wireless communications in two or more of the second downlink sub-frames to prepare second base station downlink feedback information for the two or more second downlink sub-frames; transmitting the first base station downlink feedback information to the first base station in a first time slot selected in accordance with the information specifying the division of the uplink resource for the wireless device; and transmitting the second base station downlink feedback information to the second base station in a second time slot selected in accordance with the information specifying the division of the uplink resource for the wireless device.

In some implementations, transmitting the first base station downlink feedback information can include transmitting the first base station downlink feedback information in a first uplink sub-frame in a specified frequency band to the first base station, the first uplink sub-frame being selected in accordance with the information specifying the division of the uplink resource for the wireless device, and transmitting the second base station downlink feedback information can include transmitting the second base station downlink feedback information in a second uplink sub-frame in the same specified frequency band to the second base station, the second uplink sub-frame being selected in accordance with the information specifying the division of the uplink resource for the wireless device. For example, the information specifying the division of the uplink resource for the wireless device can specify a time division of the same specified frequency band within a Frequency Division Duplex (FDD) wireless communication protocol.

The method can include alternating between individual uplink sub-frames used for the first base station and the second base station. Processing the wireless communications to prepare the first base station downlink feedback information and the second base station downlink feedback information can include calculating and storing ACK/NACK results in parallel for both the first base station and the second base station. In addition, the information specifying the division of the uplink resource for the wireless device can indicate a sub-frame n for uplink use of the first base station and a sub-frame m for uplink use of the second base station, and the method can include; determining HARQ-ACK feedback for the first base station based on a downlink sub-frame n-4 and a downlink sub-frame n-5; and determining HARQ-ACK feedback for the second base station based on a downlink sub-frame m-4 and a downlink sub-frame m-5.

According to other aspect of the described systems and techniques, a system includes: a first base station configured to support radio frequency (RF) wireless communications in a first area, the first base station being further configured to send to a wireless device in the first area information specifying a division of a common uplink resource for the wireless device; a second base station configured to support RF wireless communications in a second area that overlaps with the first area; a non-ideal backhaul coupling the second base station with the first base station; and the wireless device configured to send and receive wireless communications with both the first base station and the second base station when in both the first a and the second area, wherein the wireless device is further configured to transmit in the common RE uplink resource separate downlink feedbacks to the first base station and the second base station, at separate times, in accordance with the information specifying the division.

In some implementations, the wireless device is configured to transmit the separate downlink feedbacks to the first base station and the second base station in different sub-frames over a single frequency band. In some implementations, the wireless device is configured to transmit the separate downlink feedbacks to the first base station and the second base station in different, non-interfering time slots over two respective frequency bands. For example, the two respective frequency bands can be a frequency band of 1850-1910 MHz and a frequency band of 1710-1755 MHz.

The described systems and techniques implemented in electronic circuitry, computer hardware, firmware, software, or in combinations of them, such as the structural means disclosed in this specification and structural equivalents thereof. This can include at least one computer-readable medium embodying a program operable to cause one or more data processing apparatus (e.g., a signal processing device including a programmable hardware processor) to perform operations described. Thus, program implementations can be realized from a disclosed method, system, or apparatus, and apparatus implementations can be realized from a disclosed system, computer-readable medium, or method. Similarly, method implementations can be realized from a disclosed system, computer-readable medium, or apparatus, and system implementations can be realized from a disclosed method, computer-readable medium, or apparatus.

For example, the disclosed embodiment(s) below can be implemented in various systems and apparatus, including, but not limited to, a special purpose data processing apparatus (e.g., a wireless access point, a remote environment monitor, a router, a switch, a computer system component, a medium access unit), a mobile data processing apparatus (e.g., a wireless client, a cellular telephone, a personal digital assistant (PDA), a mobile computer, a digital camera, a general purpose data processing apparatus (e.g., a minicomputer, a server, a mainframe, a supercomputer), or combinations of these.

The described systems and techniques can result in one or more of the following advantages. Long Term Evolution (LTE) Dual Connectivity (DC) for a user equipment (UE) of type 1 can be implemented to enable UE with merely a single carrier sending capability to communicate with both a macro cell station and a micro cell station using a single uplink carrier. The high design costs associated with corresponding radio frequency integrated circuits (RFICs) can be reduced since interference between two sending paths need not be accommodated. Compared with the UE type 2, the UE type 1 merely needs one RF sending path, which can reduce the cost of the UE, such that the design of the corresponding RFIC becomes easier and is therefore more suitable for commercialization.

In various implementations, methods and an apparatus support DC based on the UE type 1 in two manners, including a frequency division duplex LTE (FDD-LTE) manner and a time division duplex LTE (TDD-LTE) manner. In some embodiments of the present disclosure, a network notifies a time division uplink resource to a UE, the UE sends feedback to a macro cell on an uplink carrier through some sub-frames, and the UE also sends feedback to a micro cell on the same uplink carrier through other sub-frames. In addition, in some embodiments, the UE can send different frequency band signals at different times, and the UE sends feedback to a macro cell on a first uplink carrier (e.g., within Band 2 in LTE) through some sub-frames, and the UE also sends feedback to a micro cell on a second uplink carrier (e.g., within Band 4 in LTE) through other sub-frames. In some implementations, the UE calculates and stores an acknowledgement/negative acknowledgement (ACK/NACK) result respectively for the macro cell and the micro cell by using a downlink decoder.

In some embodiments of the present disclosure, e.g., for FDD-LTE, if a sub-frame n is provided for uplink use of the macro cell, the UE determines a hybrid automatic repeat request acknowledgement (HARQ-ACK) feedback based on a downlink sub-frame n-4 and a downlink sub-frame n-5 of the macro cell, and the UE can store the ACK/NACK result before transmission in sub-frame n. Thereafter, the UE sends a feedback to the macro cell. Further, in some implementations, e.g., for FDD-LTE, if a sub-frame m is provided for uplink use of the micro cell, the UE determines a HARQ-ACK feedback based on a downlink sub-frame m-4 and a downlink sub-frame m-5 of the micro cell, and the UE can store the ACK/NACK result before transmission in sub-frame m. Thereafter, the UE sends a feedback to the micro cell. Other implementations are also possible.

In some embodiments of the present disclosure, e.g., for TDD-LTE, if a sub-frame n is provided for uplink use of the macro cell, the UE determines a HARQ-ACK feedback based on a special sub-frame n-6, a downlink sub-frame n-7, and a downlink sub-frame n-8 of the macro cell, and the UE can store the ACK/NACK result before transmission in sub-frame n. Thereafter, the UE sends a feedback to the macro cell. Further, in some implementations, e.g., for TDD-LTE, if a sub-frame in is provided for uplink use of the micro cell, the UE determines a HARQ-ACK feedback based on a downlink sub-frame m-4, a special sub-frame m-7, and a downlink sub-frame m-8 of the micro cell, and the UE can store the ACK/NACK result before transmission in sub-frame in. Thereafter, the UE sends a feedback to the micro cell. Other implementations are also possible.

Details of one or more implementations are set forth in the accompanying drawings and the description below. Other features and advantages may be apparent from the description and drawings, and from the claims.

### DRAWING DESCRIPTIONS

FIG. 1A shows a schematic diagram of a wireless communication system in which Dual Connectivity (DC) is implemented.

FIG. 1B shows an example of processing hardware for user equipment in a wireless communication network.

FIG. 2A shows an example of DC used in a frame structure according to at least one embodiment of the present disclosure.

FIG. 2B shows an example of DC used in another frame structure according to at least one embodiment of the present disclosure.

FIG. 3A shows a flow chart of an example of a method of wireless communications according to at least one embodiment of the present disclosure.

FIG. 3B shows a flow chart of an example of user equipment (UE) operation in a sub-frame n according to at least one embodiment of the present disclosure.

### DETAILED DESCRIPTION

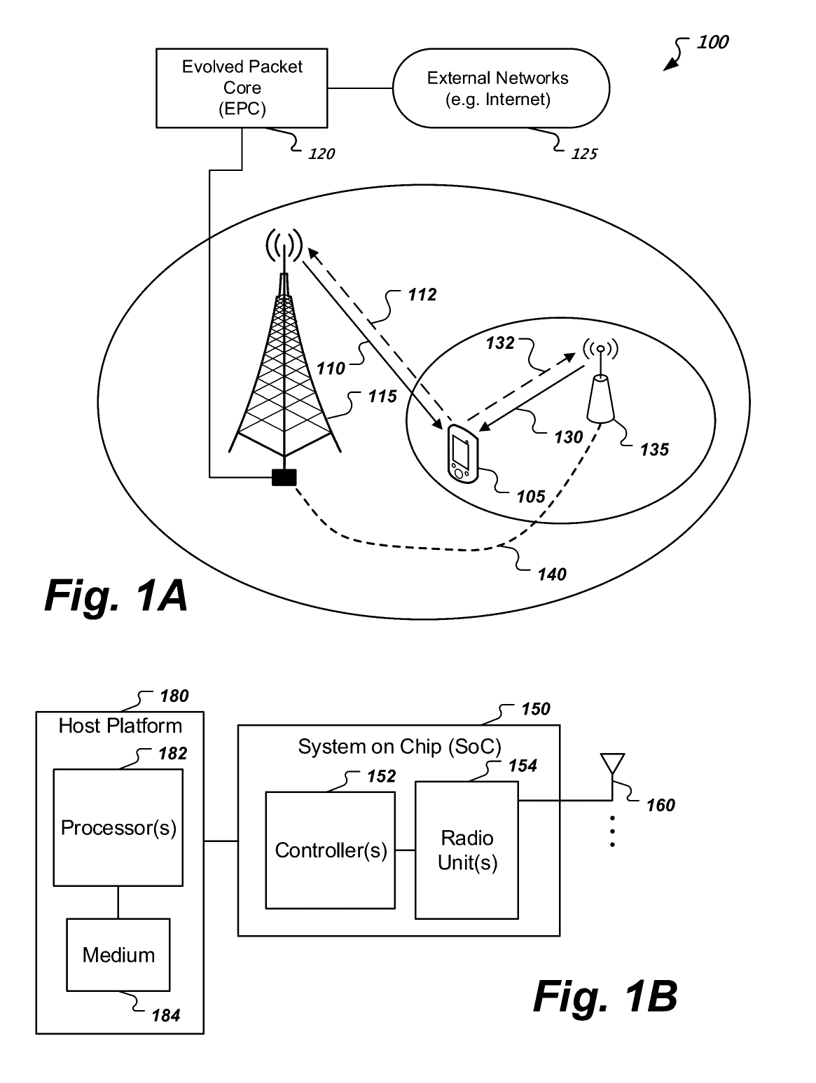

FIG. 1A shows a schematic diagram of a wireless communication system 100 in which Dual Connectivity (DC) is implemented. In this example, only the LTE (Long-Term Evolution, often referred to as 4G) wireless technology is discussed. However, the systems and techniques described are applicable to other wireless technologies that are similar to LTE in allowing the use of a non-ideal backhaul between two base stations with overlapping coverage.

The wireless communication system 100 includes one or more cellular networks made up of a number of radio cells that are each served by a base station, such as an evolved Node B (eNB) base station 115, which is also referred to as a macro cell station 115 or a macro cell 115. The cells are used to cover different areas in order to provide radio coverage over a wide area. Wireless communication devices operate in the cellular radio coverage areas that are served by the base stations, such as a device 105, which is also referred to as user equipment (UE) 105.

The wireless communication system 100 of FIG. 1A only shows one base station 115, but many other base stations can be included in a radio access network (RAN) that is known as an evolved UMTS (Universal Mobile Telecommunications System) Terrestrial Radio Access Network (eUTRAN). The base stations in the eUTRAN, e.g., macro cell station 115, provide wireless services to one or more wireless communication devices, e.g., UE 105. The base stations communicate with each other and with a core network called an evolved packet core (EPC) 120. The EPC 120 can provide wireless communication devices with access to one or more external networks 125, such as the Internet. The EPC 120 can include a mobility management entity (MME). The MME can be the main control element in the EPC 120 responsible for the functionalities, such as the control plane functions related to subscriber and session management.

The macro cell station 115 communicates directly with the UE 105, which can be any one of various types of wireless communication devices, such as a cellular phone, personal digital assistant (PDA), smartphone, laptop, or tablet computer. Further, UE 105 can include pagers, portable computers, Session Initiation Protocol (SIP) phones, one or more hardware-based processors within devices, or any other suitable processing devices capable of communicating information using a radio technology. The UE 105 can communicate directly with a serving base station to receive service when the UE 105 is operated within the cell associated with the corresponding serving station. Once a wireless connection is established, the UE 105 generates requests and responses, or otherwise communicates with the EPC 120 and the external network 125 via the macro cell station 115.

In addition to the macro cell station 115, a micro cell station 135 is also present in the system 100. The micro cell station 135 can also be referred to as a small cell, a pico cell, a femto cell, etc. Regardless of the specific size of the cell, the micro cell station 135 provides small cell enhancement to the wireless network by providing an additional base station with which the UE 105 can communicate within the macro cell area. The micro cell station 135 is coupled with the macro cell station 115 through a non-ideal backhaul 140, and the micro cell station 135 can be one of one or multiple secondary eNBs for a master eNB 115. Note that one or more such small cells can be deployed to handle extra traffic in small areas within a macro cell coverage area, to provide increased throughput for a cell's edge, or both.

The non-ideal backhaul 140 connecting the two base stations 115, 135 allows the two base stations 115, 135 to communicate with each other outside of the wireless space. The non-ideal backhaul 140 can be a cable or other physical communication link between the macro cell station 115 and the micro cell station 135. For example, the non-ideal backhaul 140 can be a wired Ethernet network, Regardless of implementation, the backhaul 140 is non-ideal in that it has communication delays (e.g., 20 millisecond or more) that are substantially larger than an ideal backhaul delay (e.g., less than 1 millisecond, or more generally, less than the length of a sub-frame). This extra delay on the backhaul 140 means downlink feedback for the micro cell station 135 cannot be sent from UE 105 to the macro cell station 115 for delivery to the micro cell station 135 over the backhaul 140, as is the case in Carrier Aggregation (CA) using an ideal backhaul.

In the DC scenario shown in FIG. 1A, the UE 105 uses radio resources provided by a macro cell 115 and a micro cell 135. As noted, the macro cell 115 and the micro cell 135 are two different network points connected by the non-ideal backhaul 140. The UE 105 can receive a downlink carrier 130 from the micro cell 135 while receiving a downlink carrier 110 from the macro cell 115 simultaneously (e.g., in a Frequency Division Duplex (FDD) implementation). However, the UE cannot send an uplink carrier 132 to the micro cell 135 while sending a different uplink carrier 112 to the macro cell 115. This is because the UE 105 uses the same RF hardware and potentially the same carrier frequency for sending wireless communications to both the macro cell station 115 and the micro cell station 135. In some cases, the use of a single uplink carrier (UE type 1) for both the macro cell and the micro cell means the common uplink resource should be shared between the macro cell and the micro cell. Thus, as shown in FIG. 1A, a first set of time slots e.g., sub-frames) 112 are used on a single uplink carrier to the macro cell 115, and second set of time slots (e.g., sub-frames) 132 are used on the same single uplink carrier the micro cell 135. Alternatively, the UE has a single carrier sending capability in that the UE 105 cannot send data on two frequency bands simultaneously, but the UE 105 can send data on two different frequency bands at different times. In this case, a first set of time slots (e.g., sub-frames) 112 are used on a first uplink carrier (e.g., Band 2 in LTE, which is a frequency band of 1850-1910 MHz) to the macro cell 115, and second set of time slots (e.g., sub-frames) 132 are used on a second uplink carrier (e.g., Band 4 in LIE, which is a frequency band of 1710-1755 MHz) to the micro cell 135.

Implementations in accordance with FIG. 1A can include various architectures using hardware, firmware and software. FIG. 1B shows an example of processing hardware for user equipment in a wireless communication network. In this example, a mobile wireless communication device includes a System on Chip (SoC) 150, one or more antennas 160, and a host platform 180. The SoC 150 represents one or more integrated circuit (IC) devices. Other configurations are possible, and the one or more IC devices (e.g., the SoC 150) can be integrated into the host platform 180.

The SoC 150 can include one or more controllers 152 and one or more radio units 154. A radio unit 154 can include a baseband unit (BBU) and a radio frequency unit (RFU) to transmit and receive signals. A radio unit 154 can include transceiver electronics that implement UE type 1, where a single uplink carrier frequency can be used to send wireless communication signals to both a macro cell and a micro cell within the macro cell area. In some implementations, radio unit(s) 154 can be designed to handle additional frequency bands and/or wireless technologies employed by the mobile wireless communication device. For example, the SoC 150 can be a combination radio chip that handles near field communications (NFC), Bluetooth (BT), WiFi, and one or more mobile phone technologies, such as WCDMA (Wideband Code Division Multiple Access), CDMA2000, UMTS, GSM (Global System for Mobile communications), High Speed Packet Access (HSPA), and LIE.

Nonetheless, the same transceiver electronics and potentially the same carrier frequency can be used to communicate with two base stations that are connected by a non-ideal backhaul, as described, e.g., FDD LTE DC using UE type 1. Thus, rather than transmitting two uplink carriers simultaneously (UE type 2) using two RF transmitting paths, only one uplink carrier need be used over one RF transmitting path, which can result in less expense and difficulty in designing the RFIC, e.g., due to not having interference between the two transmitting paths. Note that the transceiver electronics and processor electronics of the SoC 150 can include additional components that are not shown, such as one or more of each of the following: filters, amplifiers, frequency downconverters, and analog-to-digital converters.

The antenna(s) 160 can include an antenna that is shared by different wireless technologies, one or more antennas that are dedicated to a particular wireless technology, and/or two or more antennas used for a particular wireless technology. For example, in some implementations, a set of antennas 160 can be used for multiple input multiple output (MIMO) communications. Further, the controller(s) 152 can process data from, and provide control signals to, the radio unit(s) 154 and/or the host platform 180.

The host platform 180 includes one or more hardware processors 182 and at least one medium 184. The medium 184 is a non-transitory computer-readable medium (such as described further below) that can include firmware or software that operates on the processor(s) 182, the controller(s) 152, or both. In some implementations, a DSP (digital signal processor) performs the operations described herein. In some implementations, a controller 152 is a microcontroller that performed the described operations under the control of firmware, e.g., microcode embedded in a non-transitory memory device located in the SoC 150.

Regardless of these implementation details, when dual connectivity is to be supported using a non-ideal backhaul, the communication delays associated with the non-ideal backhaul should be addressed. As a result of the communication delays associated with the non-ideal backhaul, downlink feedback for the macro cell and downlink feedback for the micro cell should be sent separately to be sure the feedback is received in a timely manner. This is in contrast to carrier aggregation in a network with an ideal backhaul, where the UE receives downlink communications from two base stations and is then able to send feedback for both to only one of the two base stations, since that one base station is able to rapidly provide the downlink feedback for the other base station (over the ideal backhaul) to that other base station.

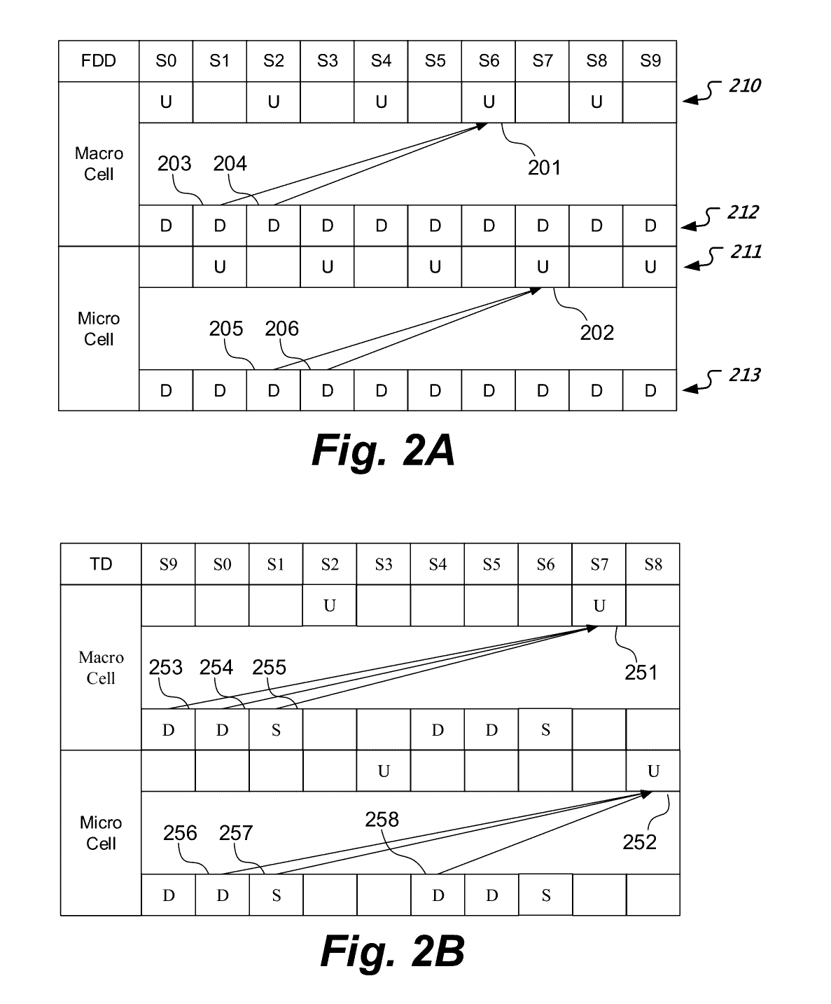

FIG. 2A shows an example of DC used in a frame structure according to at least one embodiment of the present disclosure. This example is for FDD-LTE, but other implementations are also possible. The network notifies a UE of a timing division uplink resource assignment that the UE can use to send an uplink carrier to a first base station through some sub-frames and also use the uplink carrier to a second base station through other sub-frames. For example, the UE can use uplink sub-frames S0, S2, S4, S6 and S8 to send information to a macro cell station, and the UE can use uplink sub-frames S1, S3, S5, S7 and S9 to send information to a micro cell station, as specified by a received time division of the shared uplink resource.

Other implementations are also possible, which implementations need not alternate the assignment of individual uplink sub-frames to the macro cell and small cell respectively. For example, in a given frame, uplink sub-frames S0, S1, S4, S5, S8 and S9 can be assigned to the macro cell, and uplink sub-frames S2, S3, S6 and S7 can be assigned to the micro cell, and then these assignments can be swapped between use by the macro cell and the micro cell on alternate frames. Nonetheless, the alternation of individual sub-frame assignment between the macro cell and the micro cell can have advantages in some implementations by allowing feedback to be provided sooner after the downlink sub-frames (i.e., feedback delay can be reduced).

In the example shown in FIG. 2A for an FDD-LTE implementation, the UE can use a sub-frame 201 (e.g., S6) to send hybrid automatic repeat request acknowledgement (HARQ-ACK) feedbacks of a downlink sub-frame 203 and a downlink sub-frame 204 (e.g., S1 and S2) of the macro cell: in an assigned uplink sub-frame n, feedbacks can be provided for downlink sub-frames n-4 and n-S. In addition, the UE uses a sub-frame 202 (e.g., S7) to send HARQ-ACK feedbacks of a downlink sub-frame 205 and a downlink sub-frame 206 (e.g., S2 and S3) of the micro cell: in an assigned uplink sub-frame feedbacks can be provided for downlink sub-frames m-4 and m-5. Note that various sub-frames n and m can be designated for the uplink for sending HARQ feedback for the macro cell and the micro cell, as determined by the network (e.g., by the macro cell base station), and the wireless communication protocol (e.g., LTE) can specify how far back the downlink feedback should look the feedback on the downlink can be required to be after at least four sub-frames).

Thus, a time division method is used to support Dual Connectivity (DC) on one carrier. Note that a first subset 210 of the uplink sub-frames used with the macro cell and a second subset 211 of the uplink sub-frames used with the s all cell are all located within the same frequency band. In contrast, the downlink sub-frames 212 for the macro cell and the downlink sub-frames 213 for the small cell are in a separate frequency bands from both each other and from the common frequency band used for the uplink sub-frames. In addition, other implementations can share one or more carriers in different FDD protocols and/or TD (Time Division) protocols. For example, in some embodiments, the UE can use different carriers at different times, i.e., to send feedback to a macro cell on a first uplink carrier (e.g., within Band 2 in LTE) in a first set of time slots, and to send feedback to a micro cell on a second uplink carrier e.g., within Band 4 in LTE) through a second, different set of time slots. Note that other frequency bands in LTE can also be used, such as LTE FDD Band 1 (1920-1980 MHz), Band 3 (1710-1785 MHz), Band 7 (2500-2570 MHz), Band 10 (170-1770 MHz), Band 22 (3410-3500 MHz), Band 25 (1850-1915 MHz), and Band 28 (703-748 MHz), or LTE TDD Band 35 (1850-1910 MHz), Band 36 (1930-1990 MHz), Band 38 (2570-2620 MHz), Band 40 (2300-2400 MHz), Band 41 (2496-2690 MHz), Band 42 (3400-3600 MHz), Band 43 (3600-3800 MHz), and Band 44 (703-803 MHz).

FIG. 2B shows an example of DC used in another frame structure according to at least one embodiment of the present disclosure. This example is for TDD-LTE in uplink-downlink configuration 1, but other implementations, including different TDD-LTE uplink-downlink configurations, are also possible. In general, a network notifies a time division uplink resource to a UE, such that the UE will send an uplink carrier to a macro cell through some sub-frames (e.g., sub-frames 2, and 7), and the UE will send an uplink carrier to a micro cell through other sub-frames e.g., sub-frames 3 and 8).

In the example shown for a TDD-LTE implementation in uplink-downlink configuration the UE can use a sub-frame 251 (e.g., S7) to send HARQ-ACK feedbacks of a downlink sub-frame 253, a downlink sub-frame 254 and a special sub-frame 255 (e.g., S9, S0 and S1) of the macro cell: in an assigned uplink sub-frame n, feedbacks can be provided for sub-frames n-6, n-7 and n-8. In addition, the UE uses a sub-frame 252 (e.g., S8) to send HARQ-ACK feedbacks of a downlink sub-frame 256, a special sub-frame 257 and a downlink sub-frame 258 (e.g., S0, S1 and S4) of the micro cell: in an assigned uplink sub-frame m, feedbacks can be provided for sub-frames m-4, m-7 and m-8.

Regardless of the specific FDD or TDD implementation used, the uplink sub-frames are split between the macro cell and the micro cell such that the two base stations with overlapping coverage areas share the uplink resource between them at the sub-frame level and even if they are not full frame. Thus, the uplink channel is shared between the macro cell and micro cell in a time division manner, and a single uplink sub-frame can be used to send feedbacks to the macro cell station for more than one downlink sub-frame from the macro cell station (e.g., which are at least four sub-frames earlier), and a different single uplink sub-frame can be used to send feedbacks to the micro cell station for more than one downlink sub-frame from the micro cell station (e.g., which are at least four sub-frames earlier). Further, in other implementations, two different uplink carrier frequency bands can be used for the time slots allocated to the macro cell and the micro cell, respectively,

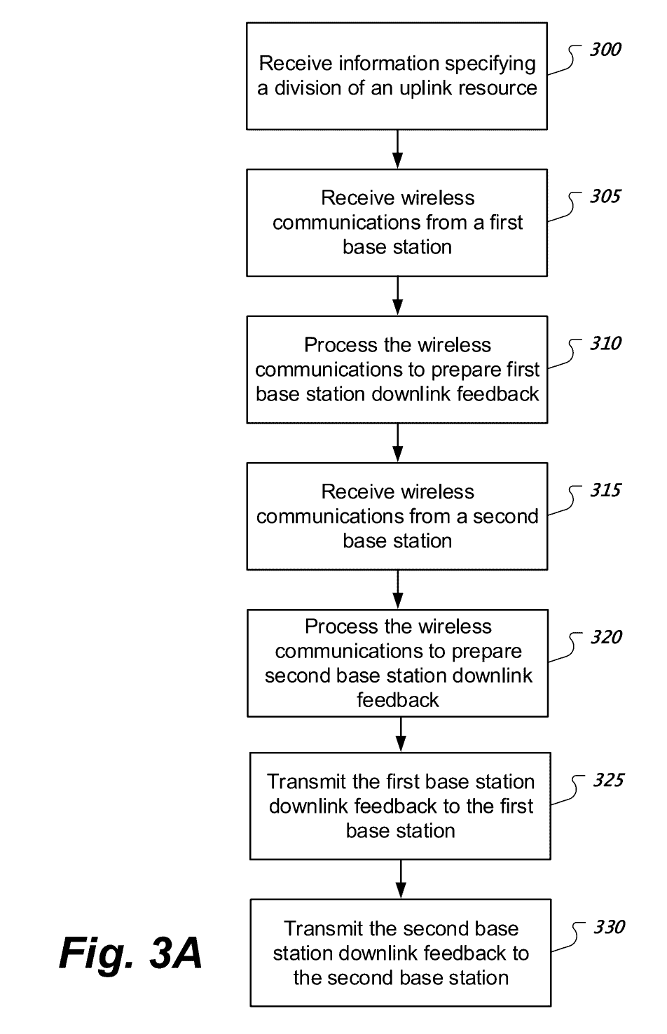

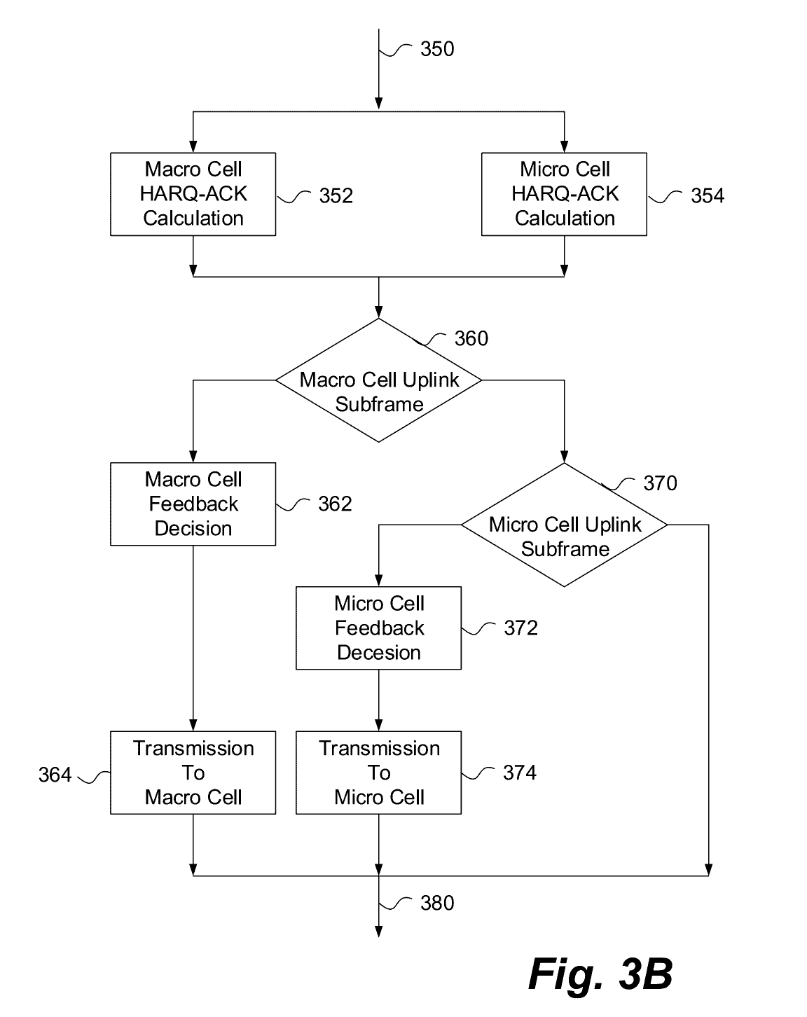

FIG. 3A shows a flow chart of an example of a method of wireless communications according to at least one embodiment of the present disclosure. The method can be performed by the wireless communication device 105 from FIG. 1A. For example, a DSP in the device 105 can run a program, which is encoded in a non-transitory machine-readable medium, to effect the method.

At 300, information specifying a division of an uplink resource is received. For example, the macro cell station 115 can notify a time division uplink resource o the UE 105, wherein this notification indicates how to share the uplink resource between the macro cell station 115 and the micro cell station 135. The shared uplink resource can be a single frequency band or two different frequency bands. Note that the resource assignments generally are controlled by the wireless network and communicated to UE 105 by base stations (e.g., eNB 115). In some implementations, a macro cell base station schedules the uplink sub-frames for itself and any micro cell base stations for each UE in the macro cell area of the macro cell base station.

At 305, wireless communications are received from a first base station (e.g., the macro cell station 115). These wireless communications can be traditional communication signals received in downlink (and other types of) sub-frames. At 310, the wireless communications are processed to prepare first base station downlink feedback information. For example, the wireless communications in two downlink sub-frames from the macro cell station 115 can be processed to prepare HARQ feedbacks for the two downlink sub-frames in an FDD-LTE implementation. As another example, the wireless communications in two downlink sub-frames and a special sub-frame from the macro cell station 135 can be processed to prepare HARQ feedbacks for these sub-frames in a TDD-LTE implementation.

At 315, wireless communications are received from a second base station (e.g., the micro cell station 135, which is coupled with the macro cell station 115 through the non-ideal backhaul 140). These wireless communications can be traditional communication signals received in downlink (and other types of) sub-frames. At 320, the wireless communications are processed to prepare second base station downlink feedback information. For example, the wireless communications in two downlink sub-frames from the micro cell station 135 can be processed to prepare HARQ feedbacks for the two downlink sub-frames in an FDD-LTE implementation. As another example, the wireless communications in two downlink sub-frames and a special sub-frame from the micro cell station 135 can be processed to prepare HARQ feedbacks for these sub-frames in a TDD-LTE implementation.

At 325, the first base station downlink feedback is transmitted to the first base station. For example, the UE 105 can transmit HARQ feedback to the macro cell station 115 in an uplink sub-frame selected in accordance with the information specifying the division of the uplink resource for the wireless device (e.g., transmit feedback information for sub-frames S1 and S2 in a sub-frame S6 in an FDD-LTE implementation, or transmit feedback information for sub-frames S9, S0 and S1 in a TDD-LTE implementation). At 330, the second base station downlink feedback is transmitted to the second base station. For example, the UE 105 can transmit HARQ feedback to the micro cell station 135 in an uplink sub-frame selected in accordance with the information specifying the division of the uplink resource for the wireless device e.g., transmit feedback information for sub-frames S2 and S3 in a sub-frame S7 in an FDD-LTE implementation, or transmit feedback information for sub-frames S0, S1 and S4 in a TDD-LTE implementation).

As will be appreciated, the method operations 305, 310, 315 and 320 can be performed serially or in parallel. For example, in an FDD-LTE implementation, the wireless communications in the downlink sub-frames can be received concurrently from the macro cell station 115 and the micro cell station 135 since their respective downlink sub-frames are in different RF channels. Likewise, one or more downlink decoders can process the wireless communications to prepare ACK/NACK results in parallel. However, since the UE cannot transmit on two frequency bands at the same time, the transmissions 325 and 330 cannot be performed simultaneously, even when two different frequency bands are used rather than a single frequency band.

FIG. 3B shows a flow chart of an example of UE operation in a sub-frame n according to at least one embodiment of the present disclosure. As shown, the operation starts at 350 and proceeds to 380, at which point, the process can repeat for another sub-frame m. At 352, the UE calculates and stores an ACK/NACK result (e.g., HARQ-ACK) for a macro cell. At 354, the UE calculates and stores an ACK/NACK result (e.g., HARQ-ACK) for a micro cell. These calculations can be performed using a downlink decoder in a known manner. These calculations can be performed in both FDD-LTE and TDD-LTE implementations.

At 360, a check is made to determine if the sub-frame at hand is a macro cell uplink sub-frame. If so, at 362, the UE determines a feedback (e.g. an HARQ-ACK feedback) based on two or more previous downlink sub-frames of the macro cell (e.g., a downlink sub-frame n-4 and a downlink sub-frame n-5 in an FDD-LTE implementation, or a special sub-frame n-6, a downlink sub-frame n-7, and a downlink sub-frame n-8 in an TDD-LTE implementation) that store the ACK/NACK result. For example, according to a network requirement, the HARQ-ACK feedback may use a physical uplink control channel (PUCCH) format 1b or a PUCCH format 3. At 364, the UE transmits a feedback to the macro cell station.

At 370, a check is made to determine if the sub-frame at hand is a micro cell uplink sub-frame. If so, at 372, the UE determines a feedback (e.g. an HARQ-ACK feedback) based on two or more previous downlink sub-frames of the micro cell (e.g., a downlink sub-frame n-4 and a downlink sub-frame n-5 in an FDD-LTE implementation, or a downlink sub-frame n-4, a special sub-frame n-7, and a downlink sub-frame n-8 in an TDD-LTE implementation) that store the ACK/NACK result. For example, according to the network requirement, the HARQ-ACK feedback may use the PUCCH format 1b or the PUCCH format 3. At 374, the UE transmits a feedback to the micro cell station. The process then repeats for a next sub-frame assigned for uplink feedback.

In view of the above, the present disclosure provides a method and an apparatus for supporting DC based on the UE type 1. Note that Dual Connectivity (DC) is distinct from Carrier Aggregation (CA) where feedback for both a macro cell and a micro cell can be sent by the UE to only one base station, since DC requires the separate feedbacks for macro cell and micro cell be separately sent by the UE to the macro cell station and micro cell station. Further, the present disclosure provides DC support in at least two different manners, including a frequency division duplex LTE (MD-LTE) manner and a time division duplex LTE (TDD-LTE) manner. The method is based on the UE type 1 that merely has one carrier sending capability at a time, and therefore, the problem caused by interference between sending paths of the UE type 2 is avoided, thereby reducing the cost of the UE and the cost of designing a corresponding RFIC. In general, a time division sharing method of the uplink resource is described, where the uplink channel is divided between the macro cell and then micro cell, and the implementation details will vary depending on the specific type of wireless communication protocol used (e.g., FDD-LTE or TDD-LTE) and the resources the wireless network has available for the UE.

A few embodiments have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof, including potentially a program operable to cause one or more data processing apparatus to perform the operations described (such as a program encoded in a computer-readable medium, which can be a memory device, a storage device, a machine-readable storage substrate, or other physical, machine-readable medium, or a combination of one or more of them).

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A program (also known as a computer program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A program can be deployed to be executed on one computer or on multiple computers that are located at one site or distributed across multiple sites and interconnected by a communication network.

While this specification contains many specifics, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may he directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

Other embodiments fall within the scope of the following claims.

What is claimed is:

1. A communication device comprising:
a radio unit configured to communicate wirelessly in accordance with a wireless communication system; and
a controller coupled with the radio unit, the controller configured to (i) obtain a time division uplink resource that indicates both a first set of time slots and a second set of time slots, which are different than the first set, to support dual connectivity with a macro cell station and a micro cell station of the wireless communication system in which the macro cell station and the micro cell station are coupled with each other through a non-ideal backhaul, (ii) send first feedback data to the macro cell station using the first set of time slots, and (iii) send second feedback data to the micro cell station using the second set of time slots.

2. The communication device of claim 1, wherein the radio unit is configured to communicate wirelessly over a radio frequency (RF) sending path in accordance with the wireless communication system specifying sub-frames used to communicate wirelessly over the RF sending path, the time division uplink resource indicates both a first proper subset of the sub-frames as the first set of time slots and a second proper subset of the sub-frames as the second set of time slots, and the controller is configured to:
send the first feedback data to the macro cell station on an uplink carrier using the first proper subset of the sub-frames over the RF sending path; and
send the second feedback data to the micro cell station on the same uplink carrier using the second proper subset of the sub-frames over the same RF sending path.

3. The communication device of claim 1, wherein the time division uplink resource indicates the first and second proper subsets of sub-frames within a Frequency Division Duplex (FDD) wireless communication protocol.

4. The communication device of claim 3, wherein the first proper subset of the sub-frames are sub-frames 0, 2, 4, 6 and 8, and the second proper subset of the sub-frames are sub-frames 1, 3, 5, 7 and 9.

5. The communication device of claim 3, wherein the controller is configured to calculate and store acknowledgement/negative acknowledgement (ACK/NACK) results for both the macro cell station and the micro cell station using a downlink decoder.

6. The communication device of claim 5, wherein the time division uplink resource indicates a sub-frame n for uplink use of the macro cell station and a sub-frame m for uplink use of the micro cell station, and the controller is configured to (i) determine hybrid automatic repeat request acknowledgement (HARQ-ACK) feedback for the macro cell station based on a downlink sub-frame n-4 and a downlink sub-frame n-5, and (ii) determine HARQ-ACK feedback for the micro cell station based on a downlink sub-frame m-4 and a downlink sub-frame m-5.

7. The communication device of claim 6, wherein the time division uplink resource specifies that the sub-frame m is a next sub-frame immediately after the sub-frame n.

8. The communication device of claim 1, wherein the wireless communication system is an LTE (Long-Term Evolution) wireless communication system, and the controller is configured to:
send the first feedback data to the macro cell station on a first uplink channel in a frequency band of 1850-1910 MHz; and
send the second feedback data to the micro cell station on a second uplink channel in a frequency band of 1710-1755 MHz.

9. A method comprising:
receiving from a first base station, at a wireless device, information specifying a division of an uplink resource for the wireless device, wherein the first base station supports radio frequency (RF) wireless communications in a first area;
receiving from the first base station, at the wireless device, wireless communications in first downlink sub-frames;
receiving from a second base station, at the wireless device, wireless communications in second downlink sub-frames, wherein the second base station supports RF wireless communications in a second area that overlaps with the first area, and the second base station is coupled with the first base station through a non-ideal backhaul;
processing the wireless communications in two or more of the first downlink sub-frames to prepare first base station downlink feedback information for the two or more first downlink sub-frames;
processing the wireless communications in two or more of the second downlink sub-frames to prepare second base station downlink feedback information for the two or more second downlink sub-frames;
transmitting the first base station downlink feedback information to the first base station in a first time slot selected in accordance with the information specifying the division of the uplink resource for the wireless device; and
transmitting the second base station downlink feedback information to the second base station in a second time slot selected in accordance with the information specifying the division of the uplink resource for the wireless device.

10. The method of claim 9, wherein transmitting the first base station downlink feedback information comprises transmitting the first base station downlink feedback information in a first uplink sub-frame in a specified frequency band to the first base station, the first uplink sub-frame being selected in accordance with the information specifying the division of the uplink resource for the wireless device, and transmitting the second base station downlink feedback information comprises transmitting the second base station downlink feedback information in a second uplink sub-frame in the same specified frequency band to the second base station, the second uplink sub-frame being selected in accordance with the information specifying the division of the uplink resource for the wireless device.

11. The method of claim 10, wherein the information specifying the division of the uplink resource for the wireless device specifies a time division of the same specified frequency band within a Frequency Division Duplex (FDD) wireless communication protocol.

12. The method of claim 11, comprising alternating between individual uplink sub-frames used for the first base station and the second base station.

13. The method of claim 11, wherein processing the wireless communications to prepare the first base station downlink feedback information and the second base station downlink feedback information comprises calculating and storing acknowledgement/negative acknowledgement (ACK/NACK) results in parallel for both the first base station and the second base station.

14. The method of claim 13, wherein the information specifying the division of the uplink resource for the wireless device indicates a sub-frame n for uplink use of the first base station and a sub-frame m for uplink use of the second base station, and the method comprises:
determining hybrid automatic repeat request acknowledgement (HARQ-ACK) feedback for the first base station based on a downlink sub-frame n-4 and a downlink sub-frame n-5; and
determining HARQ-ACK feedback for the second base station base on a downlink sub-frame m-4 and a downlink sub-frame m-5.

15. The method of claim 14, wherein the information specifying the division of the uplink resource for the wireless device specifies that the sub-frame m is a next sub-frame immediately after the sub-frame n.

16. The method of claim 9, comprising processing the wireless communications in accordance with an LTE (Long-Term Evolution) wireless communication protocol, and Wherein transmitting the first base station downlink feedback information comprises transmitting the first base station downlink feedback information to the first base station on a first uplink channel in a frequency band of 1850-1910 MHz, and transmitting the second base station downlink feedback information comprises transmitting the second base station downlink feedback information to the second base station on a second uplink channel in a frequency band of 1710-1755 MHz.

17. A system comprising:
a first base station configured to support radio frequency (RF) wireless communications in a first area, the first base station being further configured to send to a wireless device in the first area information specifying a division of a common uplink resource for the wireless device;
a second base station configured to support RF wireless communications in a second area that overlaps with the first area;
a non-ideal backhaul coupling the second base station with the first base station; and
the wireless device configured to send and receive wireless communications with both the first base station and the second base station when in both the first area and the second area, wherein the wireless device is further configured to transmit in the common RF uplink resource separate downlink feedbacks to the first base station and the second base station, at separate times, in accordance with the information specifying the division.

18. The system of claim 17, wherein the wireless device is configured to transmit the separate downlink feedbacks to the first base station and the second base station in different sub-frames over a single frequency band.

19. The system of claim 17, wherein the wireless device is configured to transmit the separate downlink feedbacks to the first base station and the second base station in different, non-interfering time slots over two respective frequency bands.

20. The system of claim 19, wherein the two respective frequency bands are a frequency band of 1850-1910 MHz and a frequency band of 1710-1755 MHz.
